(19) United States
(12) Patent Application Publication
(10) Pub. No.: US 2012/0229672 A1
(43) Pub. Date: Sep. 13, 2012

(54) DISTRIBUTED IMAGE ACQUISITION AND STORAGE SYSTEM

(76) Inventors: Ronald Steven Cok, Rochester, NY (US); Dale Frederick McIntyre, Honeoye Falls, NY (US); Timothy L. Nichols, Spencerport, NY (US); Joseph Anthony Manico, Rochester, NY (US); Symon James Whitehorn, Mendon, NY (US)

(21) Appl. No.: 13/042,501

(22) Filed: Mar. 8, 2011

(51) Int. Cl. H04N 5/76

(52) U.S. Cl. 348/231.2; 348/E05.031

(57) ABSTRACT

A distributed image acquisition and storage system connected to a communication network includes one or more digital cameras, each digital camera having a digital image sensor that acquires digital images, a unique camera identifier, and a current user identifier, and further includes one or more storage devices, each storage device having a digital memory that store the acquired digital images and a unique storage identifier, and further including a computer server. Connections, communications, and access privileges between the various system components is described.

Reference is made to commonly assigned U.S. patent application Ser. No. ______ filed concurrently herewith, entitled “Distributed Image Acquisition, Communication, and Storage System” by Ronald S. Cok, the disclosure of which is incorporated herein.

### FIELD OF THE INVENTION

The present invention relates to digital image acquisition and storage system and, in particular, to access and data transfer for distributed storage systems.

### BACKGROUND OF THE INVENTION

Since the inception of consumer photography, over 120 years ago, numerous innovations have been developed to ease the costs and complexities of taking, viewing, and sharing photographs. The original invention of flexible roll film provided the ability to record multiple, sequential, photographs without glass plates, chemicals, and reloading cameras. This innovation combined with the simple, inexpensive, and easy to use “box camera” (U.S. Pat. No. 388,850) and centralized photo processing made picture taking more affordable and accessible. Innovations such as easy-to-load film cartridges, motorized film advance, automatic exposure, electronic flash, automatic focus, one-time use cameras, compact cameras, and zoom lenses were all directed at reducing the burden of photography. In addition, the development of integrated photo-processing equipment or “mini-labs” and “photo kiosks” made photo-processing and printing in retail environments feasible.

More recently, the development of digital cameras has provided significant benefits. Digital cameras are a common and widely used consumer electronics product, used by many people to record images and events in their lives. However, such cameras have also placed new burdens on consumer photographers. The conventional process for acquiring and managing digital images is cumbersome. Digital cameras with complex control mechanisms and modes are used to acquire images. Digital images are typically captured with an electronic sensor integrated circuit in response to a user-operated control and stored in a memory in the digital camera. After some period of time, the camera is plugged into a computer through a wired interface such as a Universal Serial Bus (USB) connector and downloaded through an interface to a computer. Wireless transfer systems employing WiFi protocols and hardware over local area networks are also known. The computer executes an image-transfer program to transfer digital images from the camera to a storage device controlled by the computer, for example rotating magnetic media such as a disk. A complex software program can then be used to manipulate, store, print, or otherwise employ the digital images. The images can be viewed, manipulated, printed, and permanently stored on the computer or with an on-line service over the Internet.

Although digital cameras eliminate the costs and complexity of film usage and processing, the user of digital photography systems must overcome a wide variety of problems. Various incompatible file formats, numerous incompatible memory card formats, image file transfer, image file storage and access, on-line image file storage, incompatible computer devices with incompatible software and interfaces, computer-centric software, and post-capture operations have all added to the complexity and costs of photography. Organization, storage, and redundant backup of personal photo collections, sometimes including many thousands of digital images and video clips, become the responsibility of the photographer. Simple photo albums, shoeboxes, and slide trays that were once the final repository of irreplaceable images were directly viewable and readily understood and used. Photographic prints, slides, and negatives are today replaced by digital-media collections. These digital-media collections are often scattered across the hard drives of several different computers, on various types of digital storage devices such as removable hard drives, optical disks, Photo CDs, CDs, DVDs, and memory cards.

On-line storage accounts provide a new method to aggregate digital media collections and assure redundant back up, but these systems require the user to periodically upload their newly acquired digital images to the on-line storage account and are subject to the rules, limitations, and fees established by the on-line storage provider. Many digital cameras require the interactive use of a computer to transfer images from the camera to a secondary storage device or system. In addition, file formats and storage devices become obsolete as new digital cameras and computers become available. All of these problems interfere with the simple pleasure of taking and using photographs. In particular, digital photography practitioners must accommodate a variety of computers and computing devices, complex, non-standard user interfaces, complex workflows, image-storage management, security challenges, and incompatible image storage formats.

The use of computer networks with a variety of connected electronic devices, including storage devices is known, for example as disclosed in U.S. Pat. No. 6,928,476 and U.S. Patent Application Publication 20050060700. U.S. Pat. No. 6,678,737 describes data management units on computer networks with associated display devices. Content management systems and networks are described in U.S. Patent Application Publication 20060026171, U.S. Patent Application Publication 20050177869, U.S. Patent Application Publication 20050125484 and U.S. Patent Application Publication 20040162900. Systems for storing, sharing, and displaying digital images in a common collection, including images obtained from digital cameras are known, for example as taught in U.S. Pat. Nos. 7,024,051; 7,724,285 and 7,675,554. However, none of these systems provide a sufficiently simple, low cost, and straightforward system or method for interacting with, managing, storing, and controlling digital images in a distributed consumer environment.

The use of WiFi wireless connectivity for communication between a camera and a computer is known. Likewise, wireless computer networks are known, as are various computer peripheral devices that interact with each other and the computer wirelessly through the computer network. Wireless data storage devices that wirelessly interact with a computer are also known. U.S. Pat. Nos. 7,742,084 and 7,701,490 describe transferring images from a digital camera to desired locations through a wireless network. Storage systems available on a network are also known and commercially available. For example, Pogoplug and Western Digital network storage devices offer access through the internet. However, such networks do not overcome all of the challenges of prior-art digital imaging systems, particularly in a distributed system with remote locations. Since many consumers eventually create image collections of thousands or tens of thousands of images, a large amount of storage can be needed.

Because digital cameras have limited memory sizes, acquired images must be frequently transferred to a computer. Furthermore, because a user's computer is generally at a single location although digital cameras are mobile, it can be inconvenient to transfer images stored in a digital camera to a computer. Thus, the usefulness of the digital camera can be limited, particularly when a user is traveling.

Users are also concerned with the security of their stored digital images. Since personal images frequently have great emotional significance to users, ensuring the survival of the digital images in case of calamity, for example a hard disk crash or a household fire or flood, is important to users. Such security is typically provided with storage backup systems operated by the computer or with on-line storage. If stored on a single memory system that fails, the images can be permanently lost. To avoid such a loss, backup systems such as RAID devices and on-line storage services are available. Despite this need, typical users do not employ backup support for their personal digital images, largely because of the complexity of such systems. Managing RAID systems can be complicated and inefficient and on-line storage services can be expensive and slow, since image collections can be transferred at slow transfer rates to the on-line service. U.S. Pat. Nos. 7,764,290 and 7,271,780 address the issue of an archival storage system with an external memory system for use with an imaging system. Secure remote access to stored information on a distributed system through a communication network is a useful capability. However, further improvements and simplifications can be made to reduce the burden on users and to further automate access.

In general, users find the interactive use of computers for receiving, storing, viewing, and using their images to be complicated, tedious, and expensive, with many barriers to access, particularly for mobile digital cameras. There is a need therefore, for an improved system and method for capturing, transferring, and storing digital images in a digital storage system.

### SUMMARY OF THE INVENTION

In accordance with the present invention, there is provided a distributed image acquisition and storage system connected to a communication network, comprising:

one or more digital cameras connected to the communication network, each digital camera having a digital image sensor that acquires digital images, a unique camera identifier, and a current user identifier;

one or more storage devices connected to the communication network, each storage device having a digital memory that stores acquired digital images and a unique storage identifier;

a computer server connected to the communication network includes an association list that associates a camera identifier, a current user identifier, and a storage identifier;

wherein the one or more digital camera(s) send to the computer server over the communication network: the camera identifier, the current user identifier, and the storage identifier of a storage device to which it is requesting access; and

wherein the computer server determines if the association list contains an entry for the associated camera identifier, current user identifier, and storage identifier and, if the association list contains such an entry, to enable communication over the communication network between the digital camera to the storage device.

The present invention provides improved convenience, storage, automation, and simplicity for users of digital image cameras. Communication between digital cameras, storage devices, and network servers are enabled with security and simplicity in a highly distributed environment that provides mobility and security to digital camera users.

### BRIEF DESCRIPTION OF THE DRAWINGS

The above and other features and advantages of the present invention will become more apparent when taken in conjunction with the following description and drawings, wherein identical reference numerals have been used, where appropriate, to designate identical features that are common to the figures, and wherein:

FIG. 1A is an illustration of a digital image system including a digital camera and a storage device with a wireless local communication channel according to an embodiment of the present invention;

FIG. 1B is an illustration of a digital image system including a digital camera and a storage device with a wired local communication channel using a dock according to an embodiment of the present invention;

FIG. 2 is a front perspective, a back perspective, and a schematic of a digital camera according to an embodiment of the present invention;

FIG. 3 is a perspective and a schematic illustration of a storage device according to an embodiment of the present invention;

FIG. 4A is an illustration of a digital image system including a digital camera, a storage device, and a computer according to another embodiment of the present invention;

FIG. 4B is an illustration of a digital image system including a digital camera, a storage device, and a computer according to an alternative embodiment of the present invention;

FIG. 4C is an illustration of a digital image system including a digital camera, a storage device, and a computer according to yet another embodiment of the present invention;

FIG. 4D is an illustration of a digital image system including a digital camera, a storage device, and a computer according to another embodiment of the present invention;

FIG. 5A is an illustration of a digital image system including a digital camera, two storage devices, and a computer according to another embodiment of the present invention;

FIG. 5B is an illustration of a digital image system including two digital cameras, a storage device, and a computer according to another embodiment of the present invention;

FIG. 6 is an illustration of a stacked group of three storage devices according to another embodiment of the present invention;

FIG. 7 is a flow diagram illustrating various methods of the present invention;

FIG. 8 is a flow diagram illustrating a method of the present invention;

FIG. 9 is an illustration of a digital image system and information flow including digital cameras, storage devices, a communication network, and a computer server according to an embodiment of the present invention;

FIG. 10 is an illustration of a digital image system and information flow including a digital camera, two storage devices, and a communication network according to an embodiment of the present invention;

FIG. 11 is an illustration of a digital image system and information flow including a digital camera, two storage devices, and a communication network according to an embodiment of the present invention;

FIG. 12Aa is an illustration of a digital image system and information flow including a computer server, and website according to an embodiment of the present invention;

FIG. 12B is an illustration of a digital image system and information flow including a computer server, and a digital camera according to an embodiment of the present invention;

FIG. 12C is an illustration of a digital image system and information flow including a computer server, and a storage device according to an embodiment of the present invention; and

FIG. 13 is a flow diagram illustrating a method of the present invention.

### DETAILED DESCRIPTION OF THE INVENTION

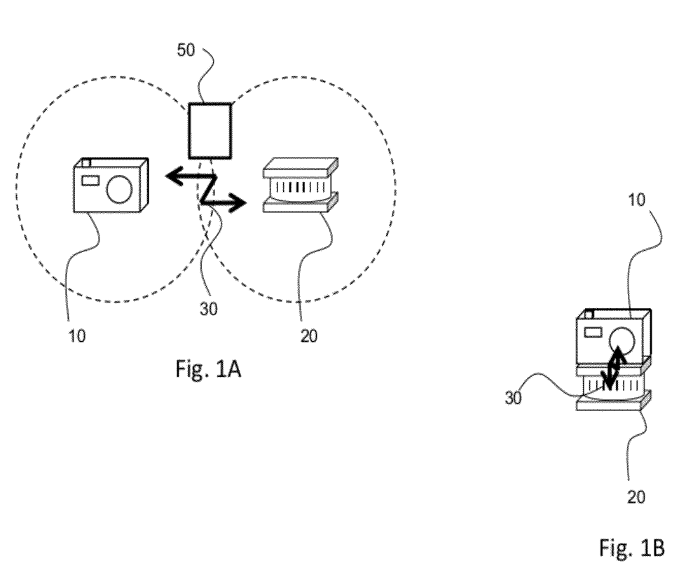

Referring to FIG. 1A, a digital-image system according to an embodiment of the present invention includes a digital camera 10 and a storage device 20 physically separate from the digital camera 10. The storage device 20 can be a non-image-display device that does not include a display for displaying information stored in the storage device 20. The digital camera 10 and the display storage device 20 interact through a local communication channel 30 to communicate information, for example digital images 50. The local communication channel 30 can be a wireless local area network (WLAN), for example a WiFi LAN or a Bluetooth point-to-point wireless connection. Alternatively, as shown in FIG. 1B, the local communication channel 30 can be a camera dock in which the dock is integrated with the storage device 20 to provide a wired, releasable electrical connection for communication for charging. Alternatively, docks can employ an inductive connection for communication or battery charging. Camera docks are known in the art, for example Eastman Kodak sells such docks. In the Figures, the dashed circles represent electromagnetic radiation communication to or from the device within the dashed circle. Physically separate devices can be connected or disconnected with a physical connector and can require an inter-device connection to communicate. For example, two physically separate devices can be in completely different geographic locations and communicate through the internet.

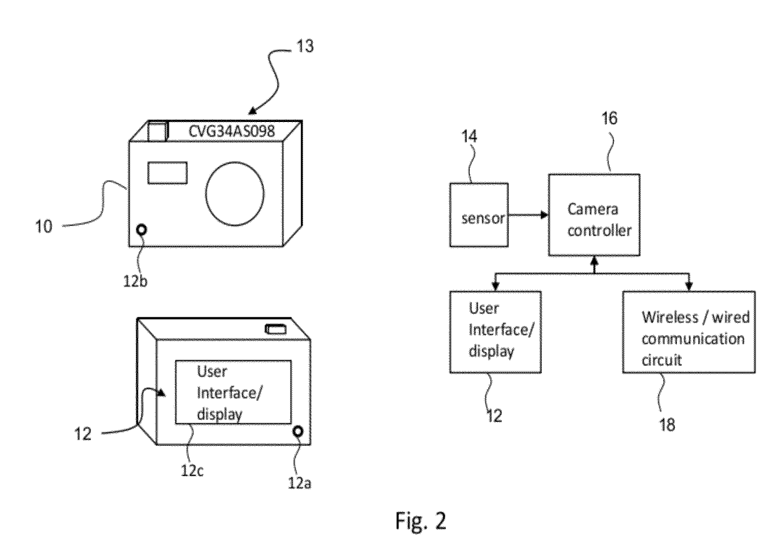

Referring further to FIG. 2, the digital camera 10 includes an image sensor 14 for acquiring digital images 50. For example, the term digital camera includes image-capture devices such as cell phones with cameras, mobile phones including image-capture devices, independent digital camera, and embedded digital cameras. The digital camera 10 includes a camera communication circuit 18, either wireless or wired, for receiving and transmitting information and digital images, a user interface 12 for interacting with a user of the digital image system, and a digital-camera controller 16 for controlling the image sensor 14, the camera wireless communication circuit 18, and the user interface 12. The user interface 12 can include an image display and control switches (not shown). In one embodiment of the present invention, the user interface 12 includes a touch screen 12c, a microphone 12b, and a speaker 12a. The digital camera 10 can include a camera identifier 13 that can be electronically stored within the digital camera 10. Image sensors 14, digital camera controller 16, wireless camera communication circuits 18, displays, switches, and touch screens employed in user interfaces 12 are all known in the electronic and computing arts. As used herein, digital images refers to still images, image sequences, video sequences, groups of images, or any multi-media element that includes images.

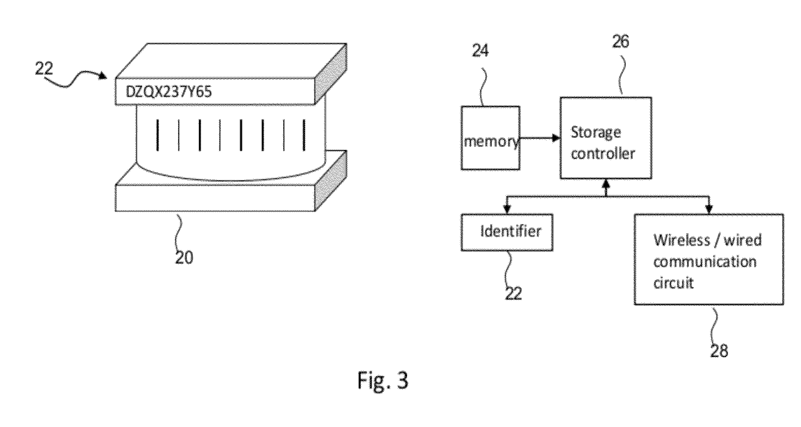

Referring to FIG. 3, the storage device 20 physically separate from the digital camera 10 includes a storage memory 24 for storing digital images 50, a storage identifier 22 that can be electronically stored within the storage device 20, a storage communication circuit 28 that communicates with the camera communication circuit 18 (FIG. 2), in either a wired or wireless fashion, and a storage controller 26 for controlling the storage memory 24 and the storage wireless communication circuit 28, the storage controller 26 enabling access to the storage memory 24 from a device that communicates the storage identifier 22. The storage device 20 can, but in a preferred embodiment does not, include an image-capable display. Storage controller 26, wireless communication circuits 28, memory (e.g. solid-state memories or disks) are known in the electronic and computing arts, as are values stored electronically or optically in memories.

Referring to FIGS. 1, 2, and 3 together, the digital-camera controller 16 is operable to receive and store the storage identifier 22 with the user interface 12 in the digital camera 10 and to communicate the storage identifier 22 to the storage device 20 as identification to enable access to the storage memory 24. The camera communication circuit 18 is operable to transfer digital images 50 to the storage device 20 and the communication storage circuit 28 is operable to receive digital images 50 from the digital camera 10 and store the received digital images 50 in the storage memory 24. The camera identifier 13 and storage identifier 22 can be stored in either or both the digital camera 10 and storage device 20 and can be used to create an association between particular digital cameras 10 and storage devices 20 and to provide identification when transferring, receiving, or storing information.

The storage device 20 is separate from the digital camera 10. As intended herein, devices that are separate from one another can be physically disconnected and operated separately and remotely. The devices can communicate wirelessly within, for example, the same room, area, or building or through a wired connection, for example provided in a camera dock. When the devices are remote, they can also communicate through an extended computer communication network such as the internet.

If the storage device (e.g. 20) is a storage device that does not have a display capable of displaying digital images 50, a user can see a digital image 50 stored in the storage device 20 by transferring and displaying the digital image 50 to another device having an image display (e.g. digital camera 10) before, after, or during a transfer of the digital image 50 to the storage device 20. Alternatively, another device having an image-capable display can communicate with the storage device 20 and display the digital image 50 communicated from the storage device 20. According to an embodiment of the present invention, the digital camera 10 is operable to communicate with the storage device 20, transmit digital images 50 to, and receive digital images 50 from, the storage device 20, and display digital images 50 on the user interface 12. The storage controller 26 and the digital-camera controller 16 are operable to transfer digital images 50 from the digital camera 10 to the storage memory 24 of the storage device 20. Likewise, the storage controller 26 and the digital-camera controller 16 are operable to transfer digital images 50 from the storage memory 24 of the storage device 20 to the digital camera 10. The user interface 12 can display digital images 50 in the digital camera 10, whether acquired by the digital camera 10 or communicated from another device such as the storage device 20. Transmitted information can include a variety of information types, for example digital images 50, handshake signals, verification and security codes, access privileges, device identifiers, user identifiers, network codes, web-site addresses, and internet protocol addresses.

The user interface 12 can include a wide variety of features. For example in one embodiment, the user interface 12 receives voice input and the digital-camera controller 16 recognizes information from the voice input.

According to an embodiment of the present invention, the user interface 12 is operable to control digital images 50 stored in the storage memory 24. By entering information through the user interface 12, a user can, for example, organize digital images 50, upload digital images 50, download digital images 50, and view digital images 50. Digital images 50 can be named, renamed, moved from one location to another in a file hierarchy, transmitted, duplicated, and deleted. In an embodiment of the present invention, the user interface 12 on the digital camera 10 remote from the storage device 20, can serve to control a digital-image storage software utility, e.g. a storage operating system, through the communication circuits 18, 28 and camera and storage device controllers 16, 26.

In one embodiment of the present invention, a digital-image system includes the digital camera 10 having the image sensor 14 for acquiring digital images 50, the camera communication circuit 18 for receiving and transmitting information and digital images 50, the user interface 12, and the digital-camera controller 16 for controlling the image sensor 14, the camera communication circuit 18, and the user interface 12. A storage device 20 remote from the digital camera 10 includes the storage memory 24 for storing digital images 50, the storage communication circuit 28 that communicates with the camera communication circuit 18, and the storage controller 26 for controlling the storage memory 24 and the storage communication circuit 28. The camera communication circuit 18 transfers digital images 50 to the storage device 20. The storage communication circuit 28 receives digital images 50 from the digital camera 10 and stores the received digital images 50 in the storage memory 24. The user interface 12 is operable to control digital images 50 stored in the storage memory 24.

According to various embodiments of the present invention, the camera and storage communication circuits 18, 28 are implemented in a variety of ways. In one embodiment, a point-to-point wireless interface, for example Bluetooth, is employed that enables direct, two-way communication between the storage device 20 and the digital camera 10. In an embodiment, the communication is enabled when the digital camera 10 and the storage device 20 are in proximity to each other, so that when the devices are no longer near each other, wireless communication does not occur. In another embodiment of the present invention, the camera and storage communication circuits 18, 28 implement a wireless local area network, such as a WiFi network, to provide a local communication channel and communicate information between the digital camera 10 and storage device 20. In yet another embodiment of the present invention, the camera and storage communication circuits 18, 28 implement an electrically connected interface through a docking structure associated with the storage device 20 and adapted to physically receive the digital camera 10 to provide a local communication channel and communicate information between the digital camera 10 and storage device 20.

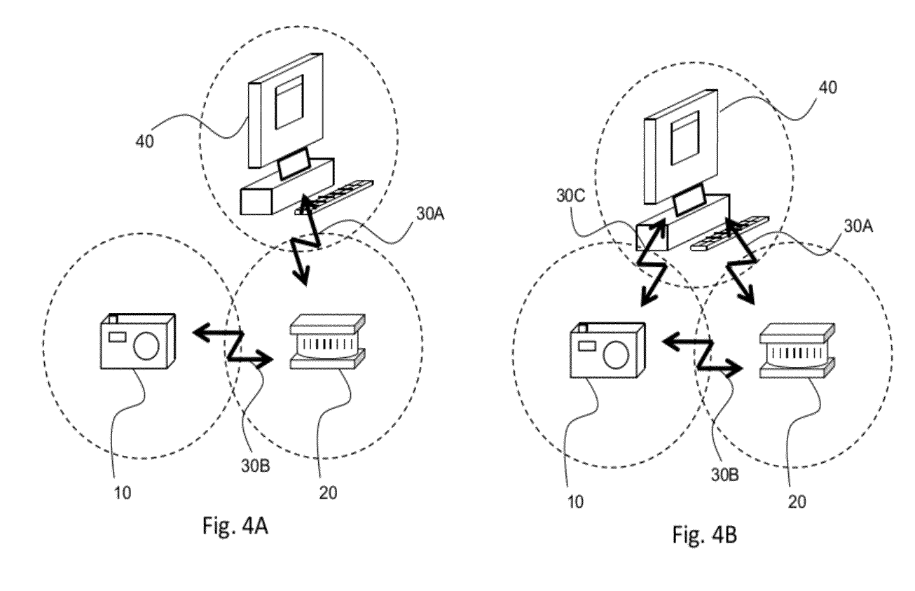

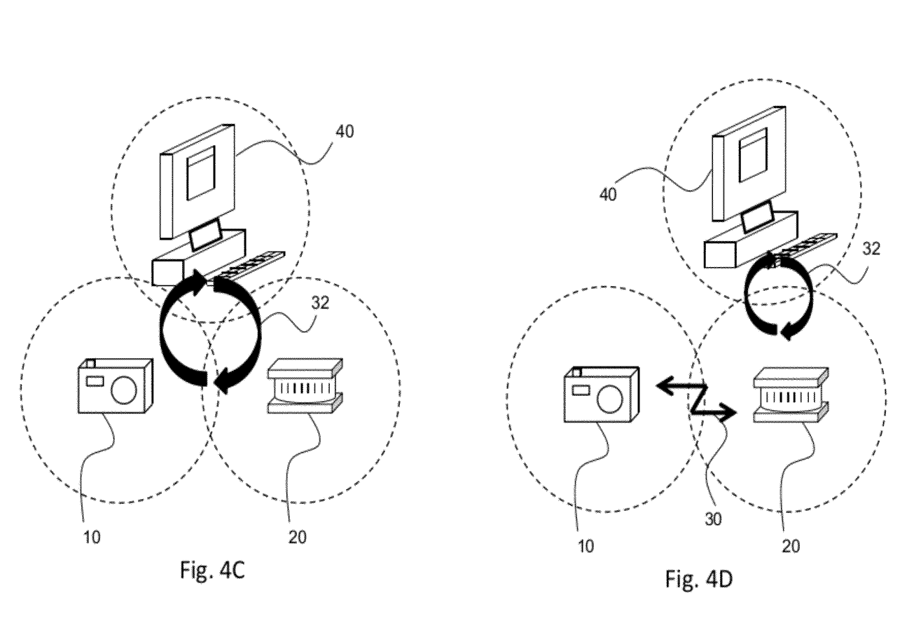

Referring to FIGS. 4A and 4B, point-to-point wireless communications between the storage device 20, the digital camera 10, and other devices can be provided. As shown in FIG. 4A, a general-purpose computer 40 is provided with a point-to-point wireless communication to the storage device 20 (but not the digital camera 10) through a wireless communication channel 30A. The storage device 20 has a separate point-to-point wireless communication to the digital camera 10 through a wireless communication channel 30B. Alternatively, as shown in FIG. 4B, the general-purpose computer 40 is provided with a point-to-point wireless communication to the storage device 20 through the wireless communication channel 30A and a separate point-to-point wireless communication to the digital camera 10 through the wireless communication channel 30C. The storage device 20 has a separate point-to-point wireless communication to the digital camera 10 through the wireless communication channel 30B.

Referring to FIG. 4C, in another embodiment of the present invention, the wireless communication forms a communication network 32 to which multiple devices can be connected. In an embodiment, the communication network 32 is controlled by the digital camera 10 or the storage device 20, or a network router (not shown) and can include a network router integrated with the digital camera 10 or the storage device 20, or can include a network router separate from the digital camera 10 or storage device 20. In this embodiment, all of the devices (digital camera 10, storage device 20, and computer 40) can communicate with each other in a single, common communication network 32. In an embodiment in which the wireless communication forms the communication network 32, both the digital camera 10 and the storage device 20 can be wirelessly connected to the same communication network 32, and other devices, for example general-purpose computers 40, can also be wirelessly connected to the communication network 32.

In an alternative embodiment of the present invention illustrated in FIG. 4D, different or additional communication structures can be employed. In one embodiment, the storage device 20 communicates with a direct, point-to-point local communication channel 30 with the digital camera 10. At the same time, in an embodiment the communication network 32 is connected to the storage device 20, for example to the general-purpose computer 40, but not to the digital camera 10. The communication network 32 connected to the storage device 20 can be a wired connection, e.g. through an Ethernet cable, or a wireless communication network, e.g. a WiFi network or a cellular network. In either of these two cases, additional devices can be connected to the communication network 32, for example routers and general-purpose computers 40. Thus, in such an embodiment, the digital camera 10 is not directly accessed by the communication network 32. In various embodiments, therefore, the local communication network 32 serves to connect the digital camera 10 to the storage device 20 and can be a direct point-to-point wired connection, a wired network, a direct point-to-point wireless connection, or a wireless network connection.

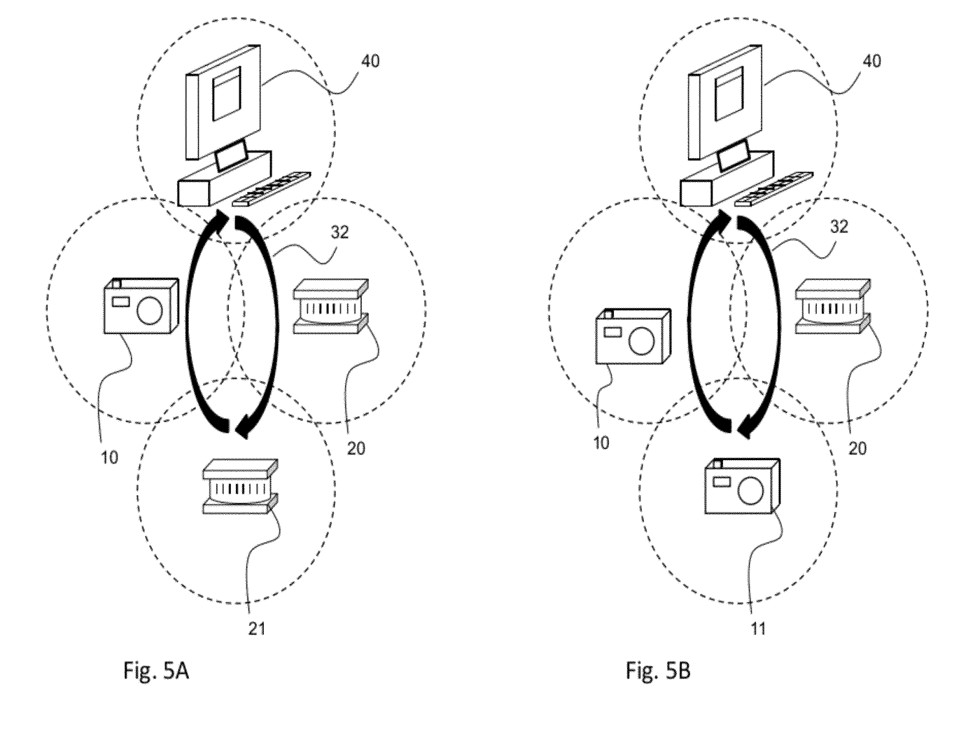

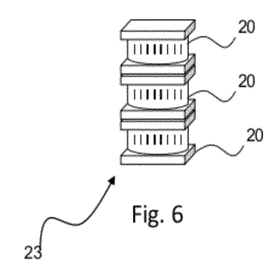

Referring to FIG. 5A, in a further embodiment of the present invention, a second storage device 21 is employed. The second storage device 21 can communicate directly with the digital camera 10 or with the storage device 20, or both. In particular, in an embodiment of the present invention, the two storage devices 20, 21 communicate with each other to provide useful digital image storage functions, for example, one storage display device (e.g. 21) can serve as a back-up to the other (e.g. 20). Alternatively, one storage device (e.g. 21) can increase the digital-image storage available to the digital camera 10. By providing suitable storage device software and intercommunication between the storage devices, a single storage system and file structure can be provided to the digital camera 10.

As noted above, a single digital camera 10 can employ multiple storage devices 20. Referring to FIG. 5B, in an alternative embodiment of the present invention, a single storage device 20 can communicate with multiple digital cameras 10. Thus, a digital system according to an embodiment of the present invention, can further include a second digital camera 11 remote from the storage device 20, the second digital camera 11 including a second image sensor for acquiring digital images 50, a second camera communication circuit for receiving and transmitting information and digital images 50, a second user interface, and a second digital-camera controller for controlling the second image sensor, the second camera communication circuit, and the second user interface. The second digital camera controller is operable to receive and store the storage identifier with the user interface in the second digital camera and to communicate the storage identifier to the storage device 20 to enable access to the image storage. The second camera communication circuit is also operable to transfer digital images 50 to the storage device 20 and the communication storage circuit is operable to receive digital images from the second digital camera 11 and store the received digital images 50 in the storage memory. In this embodiment multiple digital cameras 10, 11 employ a common storage device 20 to communicate, receive, and store digital images 50.

Referring to FIG. 6, in further embodiments of the present invention, a plurality of storage devices 23 can be employed to increase the digital-image storage capacity of the digital image system. The storage devices 20 can communicate through communication networks or point-to-point communications as described above and can use either a wired or wireless communication.

If one or more storage devices 20 are accessible to a computer network, other devices on the computer network can likewise access the storage devices 20 to read, write, modify, or organize digital images 50. If the communication network 32 is connected to a communication network 34 such as the internet, storage devices 20 can be provided with internet protocol addresses and suitable web-hosting software, or accessibility software in combination with other web sites, to provide access to the storage devices 20 over the internet. Thus, digital images 50 can be controlled from external computers or can be controlled from digital cameras 10 that are connected to the internet but are not within range of a wireless connection to the storage device 20.

In further embodiments of the present invention, the storage device 20 has an associated storage identifier 22, as illustrated in FIG. 3. The use of a storage identifier 22 provides additional control to users of the digital image system. In one embodiment, only devices that provide the storage identifier 22 to the storage device 20 can control digital images to be stored, retrieved, or organized in the storage device 20. A variety of storage identifiers 22 can be employed in various embodiments of the present invention. For example, in one embodiment, the storage identifier 22 is electronic and is stored as data within the storage device 20. The storage identifier 22 can also, or in addition, be written in characters, images, or icons on a visually readable medium associated with the storage device 20. For example, in various embodiments the storage identifier 22 is printed on a sticker affixed to the storage device 20 or printed on a sticker affixed to packaging material or documentation associated with the storage device 20. In another embodiment, the storage identifier 22 is engraved on the storage device 20 or on a plate or other medium permanently attached to the storage device 20. In yet another embodiment, the storage identifier 22 is printed on a medium that is removable from the storage device 20.

In embodiments of the present invention, the storage identifier 22 is used by the digital camera 10 to provide secure access to the storage device 20. The storage identifier 22 can be associated with the digital camera 10 in various ways. For example, in one embodiment the user interface 12 is operable to manually enter the storage identifier 22. In this case, a digital camera user interacts with the user interface 12 to enter the storage identifier 22 to the digital camera controller 16. The digital camera controller 16 can then communicate the storage identifier 22 to the storage device 20 to demonstrate to the storage device 20 that the digital camera 10 has access privileges to the storage device 20. In another embodiment, the storage identifier 22 can be communicated wirelessly from the storage device 20 to the digital camera 10. If close proximity is needed to establish wireless communication, this can be adequate to provide security to the digital camera 10 or storage device 20 user. However, in other embodiments, it can be preferred to require a manual interaction to accept the wirelessly received storage identifier 22 so that other devices that are inadvertently within wireless communication range are not inappropriately connected or confused. In this case, a user can answer a question or take a specific action with the user interface 12 to indicate the connection between the digital camera 10 and the storage device 20 (e.g. make a selection with a touch screen on a display). In one embodiment, physically docking the digital camera 10 on the storage device 20 can provide access privileges for storing transferred information. In another embodiment discussed further below, physically docking the digital camera 10 on the storage device 20 does not provide access privileges for storing transferred information.

Storage identifiers 22 can be alphanumeric sequences or strings, as shown in FIG. 3. Alternatively, storage identifiers 22 can be images or graphic symbols such as icons. In one embodiment of the present invention, the digital camera 10 is used to take a photograph of the storage identifier 22 and the digital camera controller 16 is operable to analyze the photograph and extract the storage identifier 22. In various embodiment, the storage identifier 22 is alphanumeric, an icon or image, or an encoded icon or image such as a one-dimensional or two-dimensional barcode.

Once communicated to the digital camera 10, the storage identifier 22 can be stored in the digital camera 10 and used thereafter to communicate with the storage device 20, for example to use the storage device 20 as a repository for digital images acquired by the digital camera 10. If the storage identifier 22 is not initially stored electronically in the storage device 20, it can be communicated to the storage device 20 and then stored. In many embodiments of the present invention, it is useful to maintain security for the digital camera 10, the storage device, 20 and any information stored in the storage device 20. Therefore, in some embodiments of the present invention, a security code can be employed. The storage identifier 22 can be employed as a security code, if it is communicated securely. In other embodiments, the security code can be supplementary. The security code can originate from the storage device 20, the digital camera 10, or be chosen by a user, for example in a fashion similar to the use of passwords. If chosen by a user, the security code can be entered through the user interface 12 by the user. As with the storage identifier 22, a security code can be an alphanumeric sequence or an image or icon, or other forms of information. In various embodiments, the security code is stored within the digital camera 10, the storage device 20, or both the digital camera 10 and the storage device 20, or is received from the storage device 20 and is stored within the digital camera 10. The security code can be entered each time a communication between the digital camera 10 and storage device 20 or can be automatically employed, once entered, for each communication, or some communications or actions can require that a security code be employed although other communications or actions do not.

In the cases in which multiple storage devices 20 or multiple cameras 10 are employed in an embodiment of a digital image system of the present invention, a common security code or the same storage identifier 22 can be employed by the multiple digital cameras 10 or storage devices 20. In one embodiment of the present invention, control access to the digital images 50 stored in the storage device 20 is provided equally from multiple digital cameras 10. In other embodiments, other digital cameras 10 can have restricted privileges with respect to the storage device 20. This latter embodiment, for example, can be useful if one digital camera 10 is operated by an adult and others are operated by children or those less skilled in managing digital-image collections.

Security codes for network access can also be provided for digital cameras 10 or for storage devices 20. According to an embodiment of the present invention, the digital image system includes a digital camera 10 having the image sensor 14 for acquiring digital images 50, the camera communication circuit 18 for receiving and transmitting information and digital images, the user interface 12, and the digital-camera controller 16 for controlling the image sensor 14, the camera communication circuit 18, and the user interface 12. The storage device 20 remote from the digital camera 10 includes the storage memory 24 for storing digital images 50, the storage identifier 22, the storage communication circuit 28 that communicates with the camera communication circuit 18, and the storage controller 26 for controlling the storage memory 24 and the storage communication circuit 28, the storage controller 26 enabling access to the storage memory 24 from a device that communicates the storage identifier 22. The digital camera user interface 12 and digital-camera controller 16 operate to provide a network access code for a wireless network to the storage device 20. The storage device 20 is responsive to the network access code to access the network.

According to an embodiment of a method of the present invention, the digital camera 10 includes the image sensor 14 for acquiring digital images 50, the camera communication circuit 18 for receiving and transmitting information and digital images 50, the user interface 12, and the digital-camera controller 16 for controlling the image sensor 14, the camera communication circuit 18, and the user interface 12 are provided. A storage device 20 remote from the digital camera 10 is provided that includes the storage memory 24 for storing digital images 50, the storage communication circuit 28 that communicates with the camera communication circuit 18, and the storage controller 26 for controlling the storage memory 24 and the storage communication circuit 28. The camera communication circuit 18 is operable to transfer digital images 50 to the storage device 20 and the storage communication circuit 28 is operable to receive digital images 50 from the digital camera 10 and store the received digital images 50 in the storage memory 24 and the user interface 12 is operable to control digital images 50 stored in the storage memory 24. In a further embodiment of the present invention, the storage device 20 is provided with the storage identifier 22. The digital camera controller 16 is operable to receive and store the storage identifier 22 with the user interface 12 in the digital camera 10 and to communicate the storage identifier 22 to the storage device 20 to enable access to the storage memory 24.

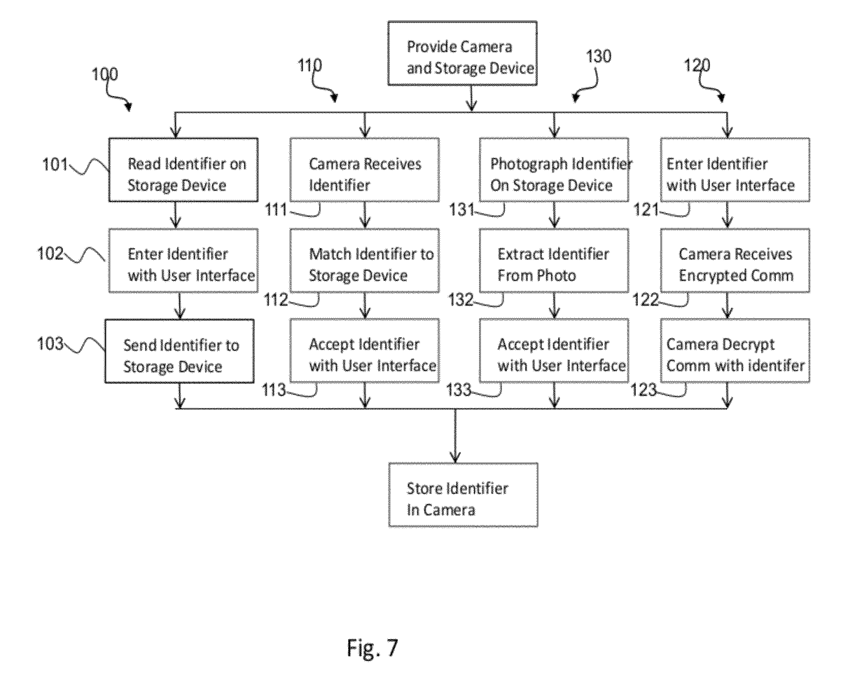

A variety of methods are employed in various embodiments to enable the present invention. Referring to FIG. 7, a variety of embodiments is illustrated. In FIG. 7, one of the paths (100, 110, 120, or 130) is used to provide and communicate the storage identifier 22. In one embodiment, illustrated as path 100, the storage device 20 is provided with a printed storage identifier 22 and read (step 101), for example on the storage device 20 or a medium associated with the device. The digital camera 10 with the user interface 12 is separately provided and the storage identifier 22 manually entered into the digital camera 10 (step 102). The wireless storage device 20 receives a communication with the storage identifier 22 to establish a secure communication (step 103). In this embodiment, the communication is preferably a wired or short-distance wireless communication so that other digital camera operators do not inappropriately communicate with the storage device 20. Once the storage device 20 has received and stored the storage identifier 22, a secure communication interface is established.

In another embodiment illustrated as path 110, the storage identifier 22 is stored in the storage device 20. The storage identifier 22 is wired or wirelessly communicated to the digital camera 10 and stored (step 111). The received storage identifier 22 can be matched to a human-readable storage identifier 22 printed on or with the storage device 20 or storage device packaging that is accessible to the appropriate digital image system user only (step 112). In one embodiment, to ensure that a digital camera user desires to interact with the storage device 20, the user is required to manually enter an acceptance into the user interface 12 to accept or acknowledge the storage device 20 and storage device interactions (step 113). Again, in this embodiment, any wireless communication is preferably a short-distance communication so that other digital camera operators do not inappropriately communicate with the storage device 20. The storage identifier 22 can also be encoded as a photograph or image (step 131) used or matched directly to provide identification or the storage identifier 22 can be extracted (step 132) e.g. by optical character recognition) from the image and accepted with the user interface 12 (step 133 in path 130). Once the storage identifier 22 is provided, it can be stored in the digital camera 10 and, if needed, in the storage device 20.

In another embodiment illustrated as path 120, the storage identifier 22 is stored in the storage device 20 and provided on a printed medium. The storage identifier 22 is entered into the digital camera 10 (step 121). The storage identifier 22 serves as a key to encrypt communications (step 122) between the storage device 20 and the digital camera 10. Since both devices have the same key, the communication is decrypted by the receiver to establish communication (step 123). Alternatively, the storage identifier 22 can be entered into the digital camera 10 before the digital camera 10 receives the encrypted communication. In yet another embodiment, after the storage identifier 22 is entered into the digital camera 10, the digital camera 10 sends an encrypted communication to the storage device 20.

To provide further security, a security code can be communicated, for example a security code selected by the user, and employed in communications between the storage device 20 and the digital camera 10. The storage identifier 22 and security code can be entered into the digital camera 10 through the user interface 12. Furthermore, communications can be encrypted, for example by using the storage identifier 22 or the security code as an encryption key. Thus, an individual that inappropriately receives wireless communications between the digital camera 10 and the storage device 20 is not able to understand the communication. In one example of the present invention, the storage identifier 22 is stored in the storage device 20, provided on or with the storage device 20 in human-readable form, and then separately entered into the digital camera 10. The storage device 20 and the digital camera 10 then communicate with an encrypted communication that is encrypted using the storage identifier 22 as a key. Since both the digital camera 10 and the storage device 20 use a common encryption key, they can decrypt the communication and communicate. Any other device that intercepts the communication cannot decrypt the communication. Unless unauthorized access is obtained to the human-readable storage identifier 22 associated with the storage device 20, this method will provide a secure interaction and connection between the digital camera 10 and the storage device 20.

In another embodiment of the present invention, a second storage device 20 is added to the digital image system. In this embodiment, the initial communications between the digital camera 10 and the second storage device 20 are the same, except that a different storage identifier 22 is employed. In various embodiments, the digital camera user interface 12 and digital camera controller 16 can operate to communicate to both or either of the storage devices 20 and the storage devices 20 can directly intercommunicate, as controlled through the digital camera user interface 12. Thus, one storage device 20 can act as an extended memory or a backup to the other.

In yet another embodiment of the present invention, a second digital camera 10 is added to the digital image system. In this embodiment, the initial communications between the second digital camera 10 and the storage device 20 are the same. The storage device 20 can communicate with both digital cameras 10, either separately or at the same time. In one embodiment, one digital camera 10 is controlled to have limited access rights to the storage device 20. In another embodiment, the two digital cameras 10 communicate directly.

The digital camera 10 and storage device 20 can communicate directly. In another method of the present invention, the communications network 32 is included in the digital image system. The communications network 32 can be accessed by the storage device 20, by the digital camera 10, or by both the digital camera 10 and the storage device 20. The communications network 32 can be provided only to the storage device 20 and can communicate with a wireless, wired, or cellular connection. According to a further method of the present invention, the communications network 32 can be connected to the internet or be the internet and the digital storage device 20 is accessed through the internet to control the digital images 50 stored on the storage device 20. In this case, access can be restricted to communications that employ the storage identifier 22 or the security code or both.

Because wireless networks can, in some circumstances, have limited communications capability, according to a method of the present invention, the digital camera 10 first communicates a low-resolution version of the digital image 50 and subsequently communicates a high-resolution version of the digital image 50. This can also be useful for other communication methods when bandwidth or time is limited.

In one method of the present invention, the digital camera 10 and the storage device 20 are purchased. The digital camera 10 is purchased with the storage device 20, and both the digital camera 10 and the storage device 20 electronically store the same storage identifier 22 or related storage identifiers 22. Both the digital camera 10 and the storage device 20 are operable to encrypt and decrypt wireless communications with the storage identifier 22. The digital camera 10 and user interface 12 are operable to provide additional instructions to the digital system to organize the storage device 20 storage as desired, for example for single or multiple users.

Thereafter, when the digital camera 10 and the storage device 20 are in proximity or connected to a common wired or wireless network, the digital camera 10 can interact with the storage 20 device using secure communications to store and retrieve information such as digital images 50. If a common network is used, the user interface 12 on the digital camera 10 can be employed to provide access codes to the network for the digital camera 10, the storage device 20, both the digital camera 10 and the storage device 20, or only one of the digital camera 10 and storage device 20. The storage device 20 can be connected to the communications network 32 although the digital camera 10 is not, or the digital camera 10 can be connected to the communications network 32 although the storage device 20 is not.

In another method of the present invention, the digital camera 10 and the storage device 20 are purchased separately. The storage device 20 electronically stores the storage identifier 22 and includes packaging material with the storage identifier 22 provided. The digital camera user interface 12 is operated to enter the storage identifier 22 into the digital camera 10. Both the digital camera 10 and the storage device 20 are operable to encrypt and decrypt communications with the storage identifier 22. The digital camera 10 interacts with the storage device 20 using the storage identifier 22 to establish a connection between the digital camera 10 and the storage device 20. The digital camera 10 and user interface 12 are operable to provide additional instructions to the digital system to organize the storage device 20 storage as desired, for example for single or multiple users. Thereafter, communications between the storage device 20 and the digital camera 10 can proceed as described above. Network access can be provided as described above.

If additional digital cameras 10 are desired to operate with the same storage device 20, the same process can be followed as described above, using the storage identifier 22. If an additional storage device 20 is desired, the additional storage identifier 22 can be provided to the digital camera 10 and communications established between the digital camera 10 and the additional storage device 20. In one embodiment of the present invention, the digital camera controller 16 and the two storage controllers 26 interoperate to organize the storage in the two storage devices 20 as a unified storage system, as desired, for example as backup, as a single extended storage space, to manage storage for multiple users, or to manage storage for multiple digital cameras 10. The storage space can also be organized to provide separate storage for each of multiple users. Each user can have a single logical storage space that can be distributed across multiple storage devices 20.

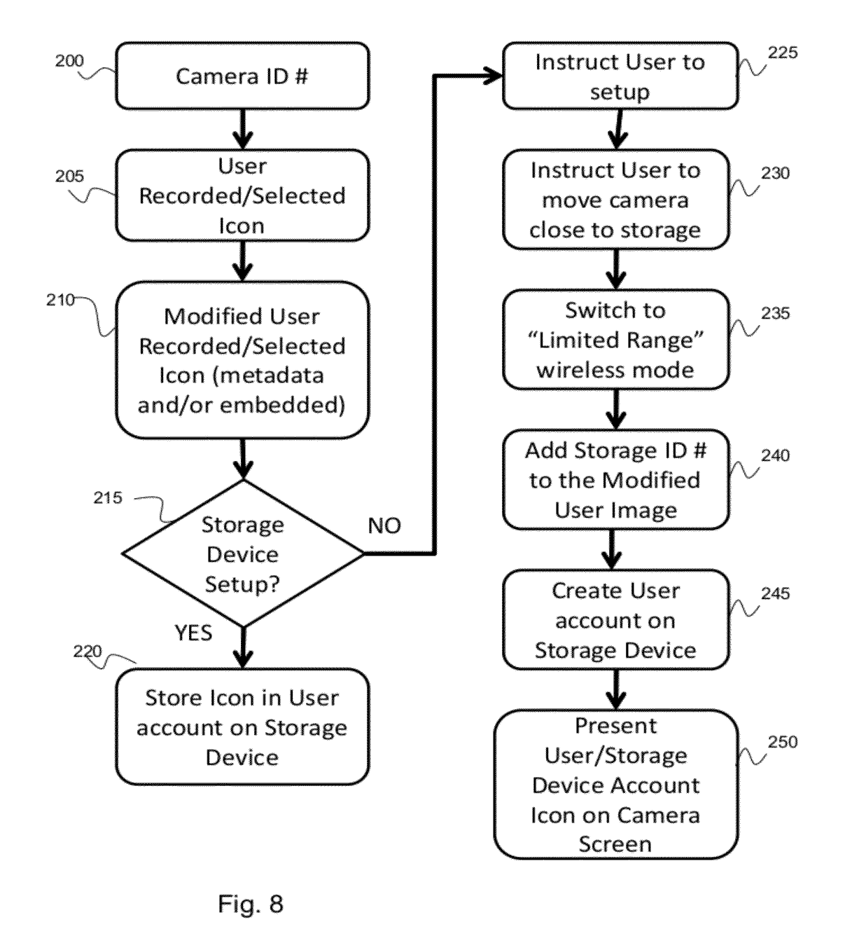

Referring to FIG. 8, in another example of one embodiment of the present invention, a graphic symbol or image is used as the storage identifier 22. FIG. 8 illustrates a process of selecting and assigning the storage identifier 22 to the digital camera 10 and storage device 20 system. In step 200, a camera identification is assigned. This assignment can be made at production or can be a storage identifier 22 provided by a user, for example through the user interface 12. In step 205, an image, graphic symbol, or icon is taken, made, or selected. For clarity in this example, the image, graphic symbol, or icon will be referred to as an icon. In step 210, the icon is modified or processed to be a suitable size and to include any useful characteristic required by the digital camera 10 or storage device 20, for example file size and format. Metadata can also be associated with the icon and stored with it, for example in the header of an image file or embedded in the image. The status of the storage device 20 is checked in step 215. If the storage device 20 is already properly associated with the desired digital camera 10 and user and the desired storage structures are organized, the icon can be transmitted to the storage device 20 and stored in the storage device 20 and associated with the user (step 220). Thereafter, when the digital camera 10 interacts with the storage device 20, by communicating the icon and comparing the communicated icon with the locally stored icon, the digital camera 10 and storage device 20 can verify the identification of the communicator to provide security in storage and communications.

If the storage device 20 is not yet organized, for example the first time the devices are started, the user can be instructed to set up the system in step 225, for example by providing a message to the user through the user interface 12. The user is instructed to move the digital camera 10 close to the storage device 20, for example to enable a proximity point-to-point communication or to enable wireless network access by the digital camera 10 in step 230. The user can be requested to enter any network codes, if needed. In a point-to-point proximity communication, such network codes are not needed. In step 235, the user is requested to set any appropriate switches in the digital camera 10 to enable communication with the storage device 20. The storage identifier 22 identifying the storage device 20, for example an alphanumeric code is associated with the icon in step 240, and communicated to the storage device 20. The storage device 20 stores the icon and organizes the storage to match the digital camera 10 request, for example by providing a user account, in step 245. In step 250, the information is presented to the user on the user interface 12 as a confirmation.

Digital cameras 10 are typically used as mobile devices to acquire images at various different locations. Although storage devices 20 are not necessarily similarly mobile, according to an embodiment of the present invention, storage devices 20 can be similarly mobile. In this embodiment, for example, a user can travel with both the digital camera 10 and the storage device 20 and periodically connect the digital camera 10 through a local communication connection (e.g. a docking procedure) to transfer digital images 50 from the digital camera 10 to the storage device 20.

In another embodiment, the digital camera 10 is mobile although the storage devices 20 are not necessarily mobile and are kept, for example at a user's home. In this situation, it is useful to be able to transfer digital images 50 acquired by the digital camera 10 to a remote storage device 20. According to an embodiment of the present invention, this can be accomplished by enabling the digital camera 10 to communicate through the local communication channel 30 to any storage device 20 that is connected to the communication network 32, even if the storage device 20 and the digital camera 10 are not associated with each other. By communication network 32 it is meant a communication network 32 that is connected to two or more storage devices 20 and for which at least one of the storage devices 20 cannot be communicated with through the local communication channel 30, for example because it is not physically accessible or two far away (out of range). For example, a communication network 32 such as the internet can interconnect two separate and different storage devices 20 in two different locations. Remotely connected storage devices 20 have separate local communication channels 30 that are not shared with the digital camera 10. Thus, the digital camera 10 that communicates through the local communication channel 30 with one storage device 20 cannot communicate through the same local communication channel 30 with another storage device 20 that is remotely connected through the communication network 32.

In this embodiment, each digital camera 10 has one or more associated storage devices 20 and one or more storage devices 20 that are not associated. The digital camera 10 can communicate locally to any storage device 20 with which it is associated, as described above. Additionally, the digital camera 10 can communicate locally with any storage device 20 with which it is not associated, for example by docking the digital camera 10 with the storage device 20. When the digital camera 10 communicates locally with a non-associated storage device 20, information is transferred from the digital camera 10 to the non-associated storage device 20. However, security permissions can be different than for communication between associated devices, for example preventing editing, viewing, or managing images stored in the local non-associated storage device 20. The non-associated storage device 20 then forwards the received information to the storage device 20 associated with the digital camera 10 through the communication network 32 or 34. The associated storage device 20 receives the information through the communication network 32 or 34 and stores the received information.

The storage devices 20 are functionally identical so that any storage device 20 can receive information from any digital camera 10. By functionally identical is meant that each storage device 20 can communicate with each digital camera 10 and forward information to any storage device 20, as needed. Functionally identical storage devices 20 can differ, for example by the amount of storage or speed of interaction or transmission, and by identification.

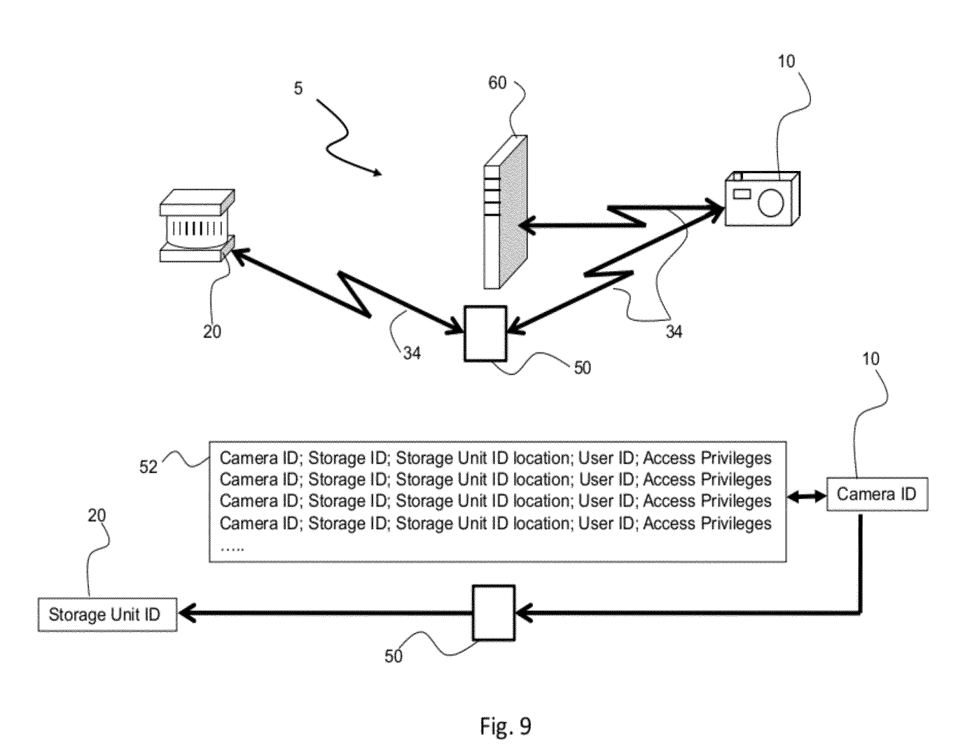

Referring to the example of FIG. 9, in one embodiment of the present invention, a distributed image acquisition and storage system 5 connected to a communication network 34 includes one or more digital cameras 10 connected to the communication network 34, each digital camera 10 having the digital image sensor 14 (FIG. 2) that acquires digital images 50, a unique camera identifier 16 (FIG. 2), and a current user identifier (shown in an association list 52). One or more storage devices 20 are connected to the communication network 34, each storage device 20 having a digital memory 24 (FIG. 3) that stores acquired digital images 50 and the unique storage identifier 22 (FIG. 3). The computer server 60 is connected to the communication network 34. The computer server 60 includes the association list 52 that associates the camera identifier 16 (FIG. 2), a current user identifier, and the storage identifier 22 (FIG. 3). The one or more digital camera(s) 10 send to the computer server 60 over the communication network 34 the camera identifier 16 (FIG. 2), the current user identifier, and the storage identifier 22 (FIG. 3) of the storage device 20 to which it is requesting access. The computer server 60 determines if the association list 52 contains an entry for the associated camera identifier 16 (FIG. 2), current user identifier, and storage identifier 22 (FIG. 3) and, if the association list 52 contains such an entry, to enable communication over the communication network 34 between the digital camera 10 and the storage device 20. The communication network 34 can be an Ethernet computer network or the internet.

The current user identifier (shown in the association list 52) can identify one unique individual, one individual of a group of individuals, or a group of individuals. The current user identifier controls access to one or more the storage devices by the one or more individual users. The digital camera 10 can include a way to identify a user, for example by accepting a code, identification, password, or an internal user registry related to use, location, ownership, or other attribute. The digital camera 10 can distinguish among a plurality of users so as to provide user identification to the computer server 60. Similarly, the association list 52 access privileges are specific to a given user on a specific digital camera 10 accessing the specific storage device 20. Hence, according to various embodiments of the present invention, a single user can have sole access to a single storage device 20, multiple users can have joint access to a single storage device 20, a single user can have sole access to multiple devices, or multiple users can have a variety of access privileges to multiple storage devices 20, depending on the association list identifications, associations, and access privileges. The association list 52 can be a table or database that stores information in records. Such databases, for example supporting the structured query language, are well known in the prior art. For example, a record can include the digital camera 10, the storage devices 20 with which it is associated for given users, the storage device network location, and the access rights (for example read, write, read or write, and delete) for the specified users and digital camera 10. Likewise, each storage device 20 can have an associated list of digital cameras 10 and user that have specified access rights. The association list 52 can include names representing other information, for example vanity names, that can be translated into more complex and less memorable text strings.

The computer server 60 can enable communication over the communication network 34 in a variety of ways in different embodiments of the present invention. The computer server 60 as used herein includes a network-addressable processing device independent of the digital camera 10 and the storage device 20. In one embodiment computer server 60 is a server connected to the internet and operated by a party other than the digital camera users or owners or the storage device users or owners. In another embodiment the computer server 60 is a computing device owned, maintained, or operated by the user or owner of the digital camera 10 or storage device 20, for example a personal computer or a home computer. As shown in FIG. 9, the digital camera 10 communicates with the computer server 60. The computer server 60 can have a fixed network address so that any digital camera 10 can communicate with the computer server 60, regardless of its physical location or network location. The digital camera 10 communicates the digital camera identifier 13, the user identifier, and the storage identifier 22 of the storage device 20 with which it desires to communicate, for example to store acquired digital images 50 or retrieve previously stored digital images 50. The computer server 60 maintains an association list 52 including information such as the camera identification, storage device identification, user identification, and access privileges. If access privileges for a specific storage device 20 cannot be granted, the requested access (e.g. digital image storage or retrieval) is not permitted.

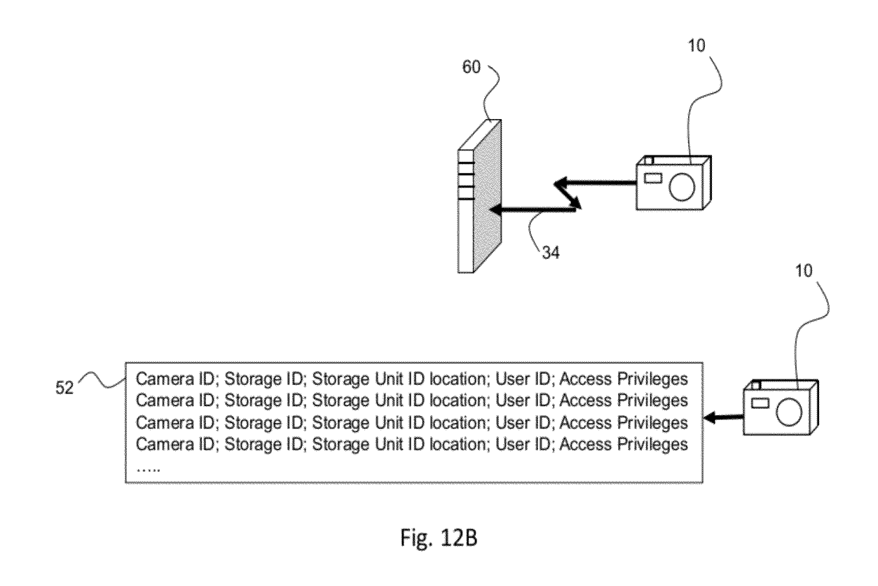

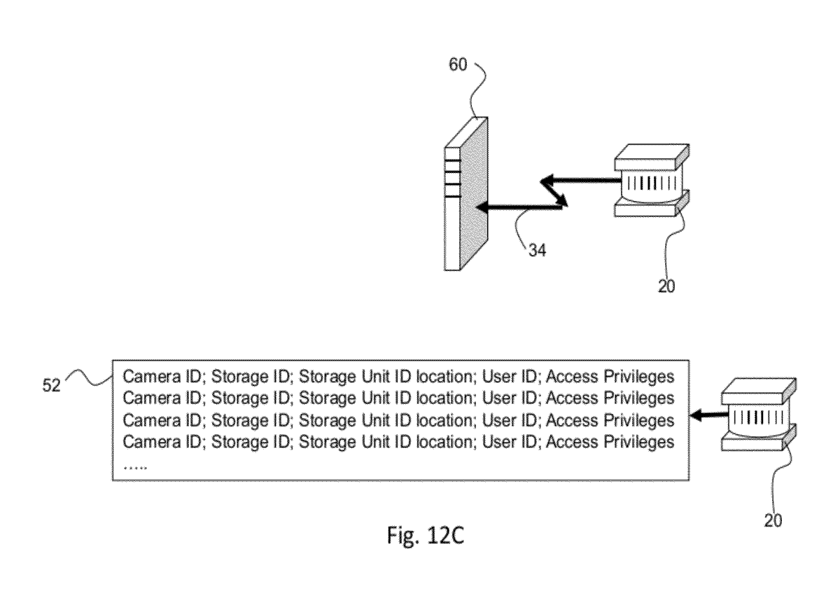

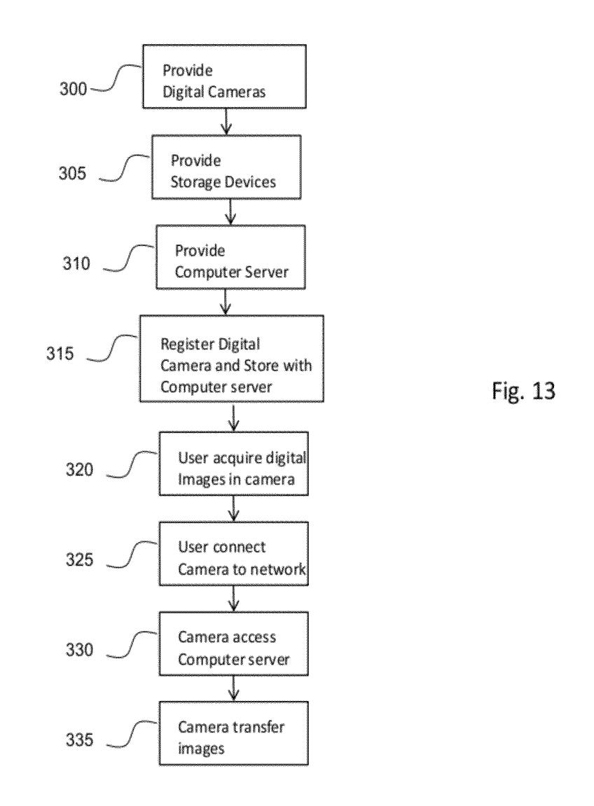

Digital camera 10 and storage device 20 information and associations can be provided to the computer server 60 when the digital camera 10 and storage device 20 are initially purchased, when it is registered, or by on-line web-browser-interaction with the computer server 60, for example by a user. FIG. 12A illustrates identifying and access privilege information 52 from a website 54 to the computer server 60 through communication network 34. Alternatively, the computer server 60 can obtain identifying and access privilege information from the digital camera 10. FIG. 12B illustrates the communication of access privilege information 52 from the digital camera 10 to the computer server 60 through communication network 34. The computer server 60 can obtain identifying and access privilege information from the storage device 20. FIG. 12C illustrates the providing access privilege information 52 from a storage device 20 to the computer server 60 through communication network 34.

The camera identification can be permanently identified with the digital camera 10 when the digital camera 10 is manufactured or the storage identification can be permanently identified with the storage device 20 when the storage device 20 is manufactured. An association between the digital camera 10 and the storage device 20 can be formed when a user purchases the digital camera 10 and the storage device 20 together, for example as a bundled sale. Alternatively, an association between the digital camera 10 and the storage device 20 can be formed when an owner of the digital camera 10 purchases a storage device 20, or vice versa.

If the digital camera 10 is found in the association list and is properly associated with the user and the storage device 20, and with suitable access privileges to the storage device 20, the computer server 60 responds to the digital camera 10 request with the network address of the storage device 20, enabling the digital camera 10 to directly transfer information, such as digital images 50, to the storage device 20.

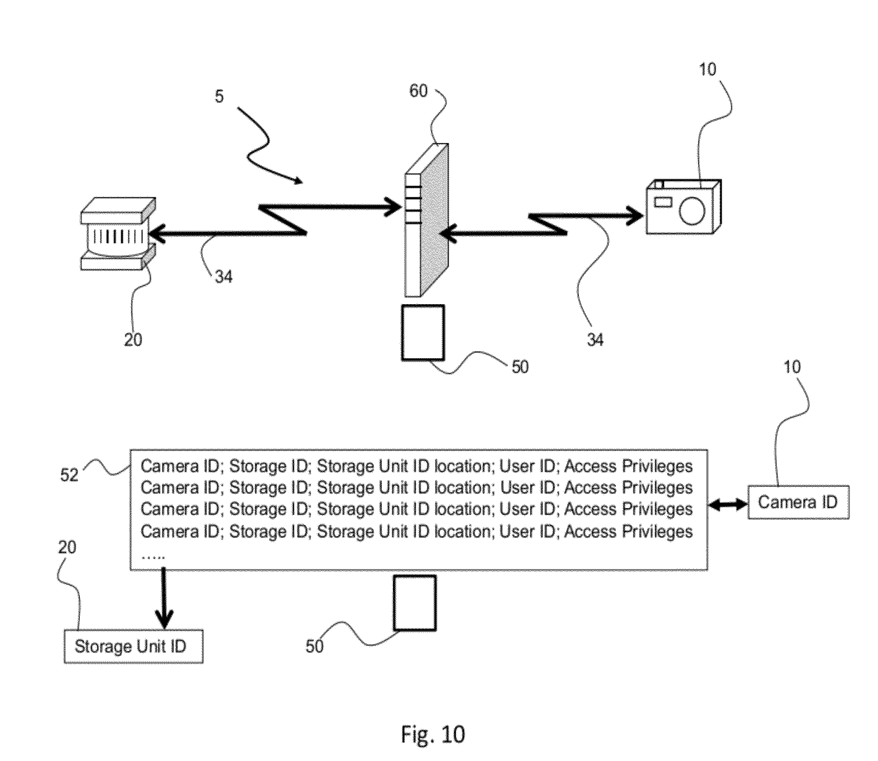

Referring to FIG. 10, in another embodiment of the present invention, the distributed image acquisition and storage system 5 includes the computer server 60. The computer server 60 enables communication by providing network connection information to the camera 10 or the storage device 20. The communication network information can be a network address, for example an internet URL, URI, or IP address. As shown in FIG. 10, the computer server 60 can interact with the digital camera 10 or the storage device 20 through communication network 34. Digital images 50 are communicated from the digital camera 10 to the computer server 60, and then communicated from the computer server 60 to the storage device 20. In this embodiment, there is no need for a direct communication between the digital camera 10 and the storage device 20, maintaining a higher level of security within the system.

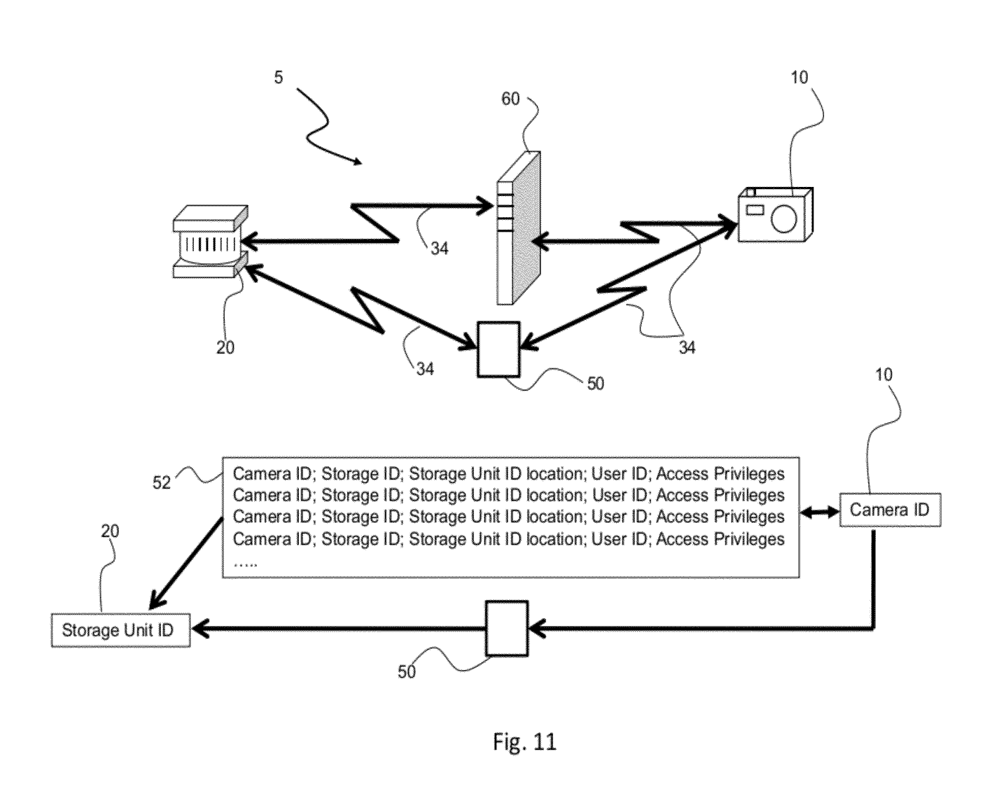

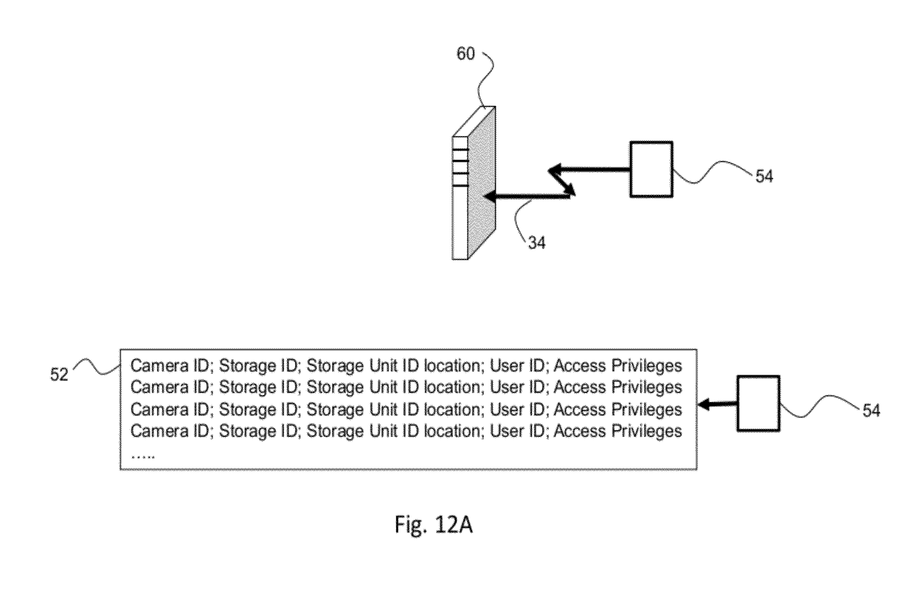

Referring to FIG. 11, when the digital camera 10 interacts with the computer server 60 in the distributed image acquisition and storage system 5, providing the computer server 60 with a camera identifier, a user identifier and the storage identifier 22 of the storage device 20 with which it desires to communicate, the computer server 60 responds with the network location of the storage device 20 on the communication network 34, if the information provided by the digital camera 10 to the computer server 60 indicates that access should be provided. In this embodiment, the computer server 60 also provides the desired storage device 20 with information regarding the digital camera 10, for example the camera identification. The storage device 20 then makes its own determination as to whether or not to accept and store the information (e.g. digital images 50) from the digital camera 10 or to retrieve and provide information to the digital camera 10.

Thus, in various embodiments of the present invention, the computer server 60 enables communication by forwarding information from the digital camera 10 to the storage device 20 or from the storage device 20 to the digital camera 10 according to access privilege information stored in the computer server 60. Likewise, the computer server 60, digital camera 10, or storage device 20 receives or transmits access privilege information to the storage device 20 or to the digital camera 10. In different embodiments, any of the devices can provide identifying information to another device, as well as assert access privileges. The computer server 60 can provide a neutral repository for associations and access privileges between digital cameras 10 and storage devices 20. The computer server 60 can enable communication by transmitting network address information and access privileges for either or both of the digital camera 10 or storage device 20 to either the digital camera 10 or storage device 20.

Referring to FIG. 13, an embodiment of the present invention can be operated by providing digital cameras 10 (step 300) and storage devices 20 (step 305) for example to a user. A computer server 60 (step 310) is provided, for example by the same company responsible for the manufacture and sale of the digital cameras 10 and storage devices 20. The digital cameras 10, storage devices 20, and computer server 60 can be provided either at the same or different times. Information identifying and associating the digital cameras 10 and storage devices 20 are entered into the association list 52 of the computer server 60 in step 315, for example by registering the devices with the computer server 60.

The user of the digital camera 10 can acquire digital images with the digital camera 10 (step 320) and then desire to store them in an associated storage device 20 at a location remote from the digital camera 10 but connected by the communication network 34, such as the internet. The user connects the digital camera 10 to the communication network 31 in step 325, accesses the computer server 60 and receives network location information from the computer server 60 in step 330, and then transfers the acquired digital images 50 to the storage device 20 in step associated with the digital camera 10 in step 335.

Thus, according to an embodiment of the present invention, a method of acquiring, storing, and accessing digital information in a distributed system connected to a communication network 34 includes: connecting one or more digital cameras 10 to the communication network 34, each digital camera 10 having the image sensor 14 that acquires digital images 50, a unique camera identifier 13, and a current user identifier (shown in an association list 52); connecting one or more storage devices 20 to the communication network 34, each storage device 20 having a storage memory 24 that stores the acquired digital images 50 and the unique storage identifier 22; and connecting the computer server 60 to the communication network 34, the computer server 60 including the association list 52 that associates the camera identifier 13, a current user identifier, and the storage identifier 22. The one or more digital camera(s) 10 send to the computer server 60 over the communication network 34 the camera identifier 13, the current user identifier, and the storage identifier 22 of the storage device 20 to which it is requesting access and the computer server 60 determines if the association list 52 contains an entry for the associated camera identifier 13, current user identifier, and storage identifier 22 and, if the association list 52 contains such an entry, to enable the communication over the communication network 34 of the digital camera 10 to the storage device 20.

In a further embodiment of the present invention, the computer server 60 receives an access request from one of the digital cameras 10, retrieves a storage device 20 reference from the association list 52, and responds with storage device digital images 50. Similarly, the computer server 60 can receive an access request from one of the storage devices 20, retrieve a digital camera 10 reference from the association list 52, and respond with digital camera digital images 50. The computer server 60 can also enable communication by forwarding digital images 50 received from one of the digital cameras 10 to one of the storage devices 20.

In another embodiment of the present invention, a distributed image acquisition and storage system 5 connected to the communication network 34 includes one or more digital cameras 10 connected to the communication network 34, each digital camera 10 having the image sensor 14 to acquire digital images 50, the unique digital camera identifier 13, and a current user identifier (shown in an association list 52). The digital cameras 10 transfer digital images 50 to one or more storage devices 20 connected to the communication network 34, each storage device 20 having the storage memory 24 to store the acquired digital images 50 and the unique storage identifier 22. The digital cameras 10 communicate with the computer server 60 connected to the communication network 34, the computer server 60 including the association list 52 that associates the digital camera identifier 13, a current user identifier, and the storage identifier 22. The one or more digital camera(s) 10 send to the computer server 60 over the communication network 34 the digital camera identifier 13, the current user identifier, and the storage identifier 22 of the storage device 20 to which it is requesting access and the computer server 60 determines if the association list 52 contains an entry for the associated digital camera identifier 13, current user identifier, and storage identifier 22 and, if the association list 52 contains such an entry, to facilitate the communication over the communication network 34 of the digital camera 10 to the storage device 20.

In another embodiment of the present invention, a method of acquiring, storing, and accessing digital information in the distributed image acquisition and storage distribution system 5 connected to the communication network 34, wherein the communication network 32 or 34 includes one or more digital cameras 10, each digital camera 10 having the image sensor 14 that acquires digital images 50, a unique digital camera identifier 13, and a current user identifier (shown in an association list 52), and further includes one or more storage devices 20, each storage device 20 having the storage memory 24 that stores acquired digital images 50 and the unique storage identifier 22, and further including the computer server 60 includes providing the association list 52 that associates the digital camera identifier 13, a current user identifier, and the storage identifier 22; sending the digital camera identifier 13, the current user identifier, and the storage identifier 22 of the storage device 20 to which the digital camera 10 is requesting access from the one or more digital camera(s) 10 to the computer server 60 over the communication network 32 or 34 and; using the computer server 60 to determine if the association list 52 contains an entry for the associated digital camera identifier 13, current user identifier, and storage identifier 22 and, if the association list 52 contains such an entry, to enable communication over the communication network 34 of the digital camera 10 to the storage device 20.

In various embodiments of the present invention, the communication network 34 can be the internet, the local communication channel 32 is a wireless or wired local area network, or the local communication channel 30 is a dock interface or point-to-point wired or wireless connection between the storage device 20 and the digital camera 10. The system can include a plurality of functionally identical storage devices 20, each having a unique communication network address identifier, for example an internet protocol address or universal resource locater or universal resource indicator. Each storage device 20 can be associated with one or more digital cameras 10. Multiple storage devices 20 can be associated with a single digital camera 10, for example to expand the available storage space or to provide backup for stored information. Each of the digital cameras 10 can include a unique communication network address and can transmit the unique communication network address identifier with the digital images 50 to the storage device 20. The functionally identical storage devices 20 can receive and store digital images 50 from digital cameras 10 with which the storage device 20 is associated and can receive and transfer or forward digital images 50 from digital cameras 10 with which the storage device 50 is not associated.

The storage devices 20 can be configured to each provide a separate and distinct single logical storage structure. Alternatively, groups of storage devices 20 together can provide a separate and distinct single logical storage structure. According to various embodiments of the present invention, a single logical storage structure can be separately provided for each identified user of the digital image system, for example for multiple users of a single digital camera 10. Alternatively, a single logical storage structure can be organized for individual digital cameras 10. In yet another alternative, a single logical storage structure is shared between multiple users or multiple digital cameras 10.

Storage devices 20 are known in the art, as are wireless circuits and communication methods. Digital computing circuits and computers are known and software to manage the transfer and organization of digital images 50 on one or multiple devices are known. Digital cameras 10 are also commercially available. These tools can be used to implement the digital image system of the present invention.

The various embodiments of the present invention provide a simplified interface for digital imaging practitioners. By employing a direct, local communication interface, communication between the digital camera 10 and storage device 20 is simplified and removes the need for intermediate computers for managing the reception and storage of digital images 50. Indeed, once the system is set up, the user need do nothing but bring the digital camera 10 into proximity with the storage device 20 to download and store digital images 50 (for a wireless local communication). Moreover, image review of stored digital images 50 can be done on the digital camera display, rather than requiring a digital computer, reducing costs for users. If remote access through a computer network is desired, simple browsing devices such as netbooks or tablet computers can be employed.

Furthermore, by enabling storage-devices 20 access through a computer network with functionally similar storage devices 20, digital images 50 can be transferred from the digital camera 10 to the storage device 20 through a communication network such as the internet without any intervention by the user. The provision of the computer server 60 having an association list 52 of identified devices together with permitted access privileges maintains the security and flexibility of the system.

The invention has been described in detail with particular reference to certain preferred embodiments thereof, but it will be understood that variations and modifications can be effected within the spirit and scope of the invention.

### PARTS LIST

5 distributed image acquisition and storage distribution system
10 digital camera
11 second digital camera
12 user interface
12a speaker
12b microphone
12c touchscreen
13 camera identifier
14 image sensor
16 digital-camera controller
18 camera communication circuit
20 storage device
21 storage device
22 storage identifier
23 plurality of storage devices
24 storage memory
26 storage controller
28 storage communication circuit
30 local communication channel
30A, 30B, 30C local wireless communication channel
32 communication network
34 remote communication network
40 computer
50 information, digital images
52 association list
54 website
60 server
100 communication path
101 read identifier on storage device step
102 enter identifier with user interface step
103 send identifier to storage device step
110 communication path
111 camera receives identifier step
112 match identifier to storage device step
113 accept identifier with user interface step
120 communication path
121 enter identifier with user interface step
122 camera receive encrypted communication step
123 camera decrypt communication with identifier step
130 communication path
131 photograph identifier on storage device step
132 extract identifier from photo step
133 accept identifier with user interface step
200 set camera id# step
205 user recorded/selected image step
210 modified image step
215 check storage device setup status step
220 store image in user account step
225 instruct user to setup step
230 instruct user to move camera step
235 switch to “limited range” step
240 add storage device id to modified user image step
245 create user account step
250 present user account icon step
300 provide digital camera step
305 provide storage device step
310 provide computer server step
315 register digital camera and storage device step
320 acquire digital images with digital camera step
325 connect camera to network step
330 camera access computer server step
335 camera transfer image step

1. A distributed image acquisition and storage system connected to a communication network, comprising:
one or more digital cameras connected to the communication network, each digital camera having a digital image sensor that acquires digital images, a unique camera identifier, and a current user identifier;
one or more storage devices connected to the communication network, each storage device having a digital memory that stores acquired digital images and a unique storage identifier;
a computer server connected to the communication network includes an association list that associates a camera identifier, a current user identifier, and a storage identifier;
wherein the one or more digital camera(s) send to the computer server over the communication network: the camera identifier, the current user identifier, and the storage identifier of a storage device to which it is requesting access; and
wherein the computer server determines if the association list contains an entry for the associated camera identifier, current user identifier, and storage identifier and, if the association list contains such an entry, to enable communication over the communication network between the digital camera and the storage device.

2. The distributed image acquisition and storage system of claim 1, wherein the current user identifier identifies one or more individual users and controls access to one or more the storage devices by the one or more individual users.

3. The distributed image acquisition and storage system of claim 1, wherein the computer server enables communication over the communication network by providing connection information to the digital camera or the storage device.

4. The distributed image acquisition and storage system of claim 1, wherein the computer server enables communication by forwarding information from the digital camera to the storage device or from the storage device to the digital camera according to access privilege information stored in the computer server.

5. The distributed image acquisition and storage system of claim 1, wherein the computer server, digital camera, or storage device receives or transmits access privilege information to the storage device or to the digital camera.

6. The distributed image acquisition and storage system of claim 5, wherein the computer server enables communication by transmitting network address information to the digital camera and access privilege information to the digital camera.

7. The distributed image acquisition and storage system of claim 5, wherein the computer server enables communication by transmitting network address information to the digital camera and access privilege information to the storage device.

8. The distributed image acquisition and storage system of claim 1, wherein the computer server obtains access privilege information through a user-interactive website.

9. The distributed image acquisition and storage system of claim 1, wherein the computer server obtains access privilege information from the digital camera or from the storage device.

10. The distributed image acquisition and storage system of claim 1, wherein the computer server receives access requests from the digital camera and access permission from the storage device.

11. The distributed image acquisition and storage system of claim 1, wherein the camera identification is permanently identified with the digital camera when the digital camera is manufactured or wherein the storage identification is permanently identified with the storage device when the storage device is manufactured.

12. A method of acquiring, storing, and accessing digital information in a distributed system connected to a communication network, comprising:
connecting one or more digital cameras to the communication network, each digital camera having a digital image sensor that acquires digital images, a unique camera identifier, and a current user identifier;
connecting one or more storage devices to the communication network, each storage device having a digital memory that stores the acquired digital images and a unique storage identifier;
connecting a computer server to the communication network, the computer server including an association list that associates a camera identifier, a current user identifier, and a storage identifier;
sending the digital camera identifier, the current user identifier, and the storage identifier of the storage device to which the digital camera is requesting access from the one or more digital camera(s) to the computer server over the communication network and;
using the computer server to determine if the association list contains an entry for the associated camera identifier, current user identifier, and storage identifier and, if the association list contains such an entry, to enable communication over the communication network of the digital camera to the storage device.

13. The method of claim 12, further including receiving an access request from one of the digital cameras, retrieving a storage device reference from the association list, and responding with storage device digital images.

14. The method of claim 12, further including receiving an access request from one of the storage devices, retrieving a digital camera reference from the association list, and responding with digital camera digital images.

15. The method of claim 12, further including forwarding digital images received from one of the digital cameras to one of the storage devices.

16. A method of acquiring, storing, and accessing digital information in a distributed system connected to a communication network, wherein the network includes one or more digital cameras, each digital camera having a digital image sensor that acquires digital images, a unique camera identifier, and a current user identifier, and further includes one or more storage devices, each storage device having a digital memory that stores the acquired digital images and a unique storage identifier, and further including a computer server, the method including:
providing an association list that associates a camera identifier, a current user identifier, and a storage identifier;
sending the digital camera identifier, the current user identifier, and the storage identifier of the storage device to which the digital camera is requesting access from the one or more digital camera(s) to the computer server over the communication network; and
using the computer server to determine if the association list contains an entry for the associated camera identifier, current user identifier, and storage identifier and, if the association list contains such an entry, to enable communication over the communication network of the digital camera to the storage device.
